(19) United States
(12) Patent Application Publication
(10) Pub. No.: US 2026/0081278 A1
(43) Pub. Date: Mar. 19, 2026

(54) STRUCTURALLY INTEGRATED BATTERY PACK CIRCUITRY

(71) Applicant: Rivian IP Holdings, LLC, Irvine, CA (US)

(72) Inventors: Jonathan VERGHESE, Costa Mesa, CA (US); Daniel Kurt Mehr, Irvine, CA (US); Sunoj Cherian George, Irvine, CA (US)

(21) Appl. No.: 19/251,551

(22) Filed: Jun. 26, 2025

Related U.S. Application Data
(60) Provisional application No. 63/694,712, filed on Sep. 13, 2024.

(51) Int. Cl. H01M 50/24; B60K 1/04; B60L 50/64; B60L 58/10; B60S 5/00; H01M 10/42; H01M 50/209; H01M 50/213; H01M 50/249

(52) U.S. Cl. CPC H01M 50/24; B60K 1/04; B60L 50/64; B60L 58/10; B60S 5/00; H01M 10/425; H01M 50/209; H01M 50/213; H01M 50/249; H01M 2010/4278; H01M 2220/20

(57) ABSTRACT

Structurally integrated battery pack circuitry is disclosed. The structurally integrated battery pack circuitry may include processing circuitry, such as balancing voltage and temperature (BVT) circuitry, mounted in a support structure of an enclosure for a battery pack. The support structure may be a crossmember or a longitudinal member of the enclosure.

### CROSS REFERENCE TO RELATED APPLICATIONS

This application claims the benefit of priority to U.S. Provisional Ser. No. 63/694,712, entitled, “Structurally Integrated Battery Pack Circuitry”, filed on Sep. 13, 2024, the disclosure of which is hereby incorporated herein in its entirety.

### INTRODUCTION

Batteries are often used as a source of power, including as a source of power for electric vehicles that include wheels that are driven by an electric motor that receives power from the battery.

Aspects of the subject technology can help to improve the efficiency, serviceability, reliability, and/or range of electric vehicles, which can help to mitigate climate change by reducing greenhouse gas emissions.

### SUMMARY

In accordance with aspects an apparatus is provided that includes an enclosure for an energy volume for a battery pack, the enclosure including a support structure that at least partially defines a space within the enclosure for one or more battery cells. The support structure may be configured to house processing circuitry for monitoring one or more battery cells within the energy volume. The support structure may include a cavity for housing the processing circuitry and at least one opening for allowing cabling to pass from the space within the energy volume and external to the support structure to the processing circuitry within the cavity. The support structure may include a longitudinal member that extends from a front end of the enclosure to a rear end of the enclosure and provides front-to-rear strength for the enclosure.

The enclosure may include an additional longitudinal member, and additional processing circuitry disposed within the additional longitudinal member for monitoring the one or more battery cells. The support structure may include a crossmember that extends from a first side of the enclosure to a second side of the enclosure and provides left-to-right strength for the enclosure. The crossmember may include a rear crossmember that forms at least a portion of a rear wall of the enclosure. The crossmember may include a front crossmember that forms at least a portion of a front wall of the enclosure. The crossmember may include a bottom opening, and the processing circuitry may be serviceable, via the bottom opening, from a bottom of the battery pack. The processing circuitry may be provided in a circuitry housing that is mounted in the cavity.

The processing circuitry may be mounted directly to the support structure in the cavity, and the support structure may provide electromagnetic interference protection for the processing circuitry. The apparatus may include an electric vehicle.

In accordance with other aspects of the subject disclosure, a battery pack is provided that includes: an enclosure for an energy volume for a battery pack, the enclosure including a support structure that at least partially defines a space within the enclosure for one or more battery cells, the support structure configured to house processing circuitry for monitoring one or more battery cells within the energy volume. The battery pack of may also include the processing circuitry within the support structure. The support structure may include a cavity for housing the processing circuitry and at least one opening for allowing cabling to pass from the space within the energy volume and external to the support structure to the processing circuitry within the cavity. The support structure may include a longitudinal member that extends from a front end of the enclosure to a rear end of the enclosure and provides front-to-rear strength for the enclosure. The enclosure may include an additional longitudinal member, and additional processing circuitry disposed within the additional longitudinal member for monitoring the one or more battery cells.

The support structure may include a crossmember that extends from a first side of the enclosure to a second side of the enclosure and provides left-to-right strength for the enclosure. The processing circuitry may be mounted directly to the support structure in the cavity, and the support structure may provide electromagnetic interference protection for the processing circuitry.

In accordance with other aspects of the subject disclosure, a method of assembling a vehicle is provided, the method including: providing battery cells in a plurality of spaces within an enclosure for a battery pack, the plurality of spaces separated by at least one support structure of the enclosure; providing monitoring circuitry for the one or more battery cells within the support structure; and installing the battery pack having the monitoring circuitry within the support structure in the vehicle. The method may also include servicing the monitoring circuitry without removing the battery pack from the vehicle by, while the battery pack is installed in the vehicle: accessing a cavity within the support structure from beneath the vehicle; removing the monitoring circuitry from the cavity; and replacing the monitoring circuitry with replacement monitoring circuitry in the cavity.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a top view of a battery pack with cylindrical battery cells and battery pack processing circuitry installed therein in accordance with one or more implementations.

FIG. 4 illustrates a top view of a portion of battery pack with prismatic battery cells and processing circuitry installed therein in accordance with one or more implementations.

FIG. 5 illustrates a top view of a portion of a battery pack with prismatic cells and with battery pack processing circuitry mounted in longitudinal members of the battery pack in accordance with one or more implementations.

FIG. 6 illustrates a top view of a portion of a battery pack with prismatic cells and with processing circuitry mounted in a crossmember of the battery pack in accordance with one or more implementations.

FIG. 7 illustrates a cross-sectional end view of a battery pack with processing circuitry mounted in longitudinal members of the battery pack in accordance with one or more implementations.

FIG. 8 illustrates another cross-sectional end view of a battery pack having a structural member with processing circuitry having a circuitry housing mounted therein in accordance with one or more implementations.

FIG. 9 illustrates another cross-sectional end view of a battery pack having a structural member with processing circuitry mounted directly therein in accordance with one or more implementations.

FIG. 10 illustrates a perspective view of a structural member having processing circuitry disposed therein in accordance with one or more implementations.

FIG. 11 illustrates another perspective view of a structural member having processing circuitry disposed therein in accordance with one or more implementations.

FIG. 12 illustrates a cross-sectional side view of a portion of a battery pack in accordance with one or more implementations.

FIG. 13 illustrates a flow chart of illustrative operations that may be performed for assembling a battery pack in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to structurally integrated battery pack circuitry. The structurally integrated battery pack circuitry may include processing circuitry, such as balancing voltage and temperature (BVT) circuitry, mounted in a support structure of an enclosure for a battery pack.

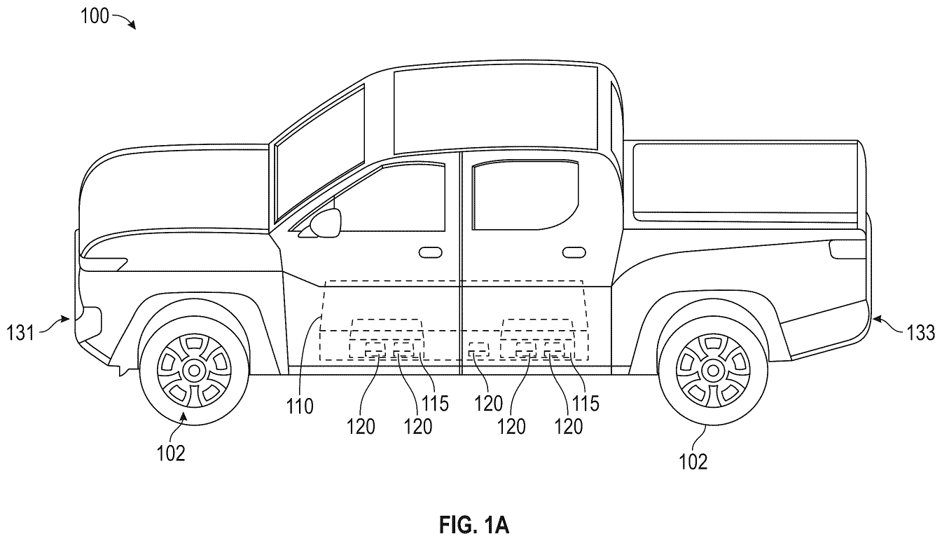

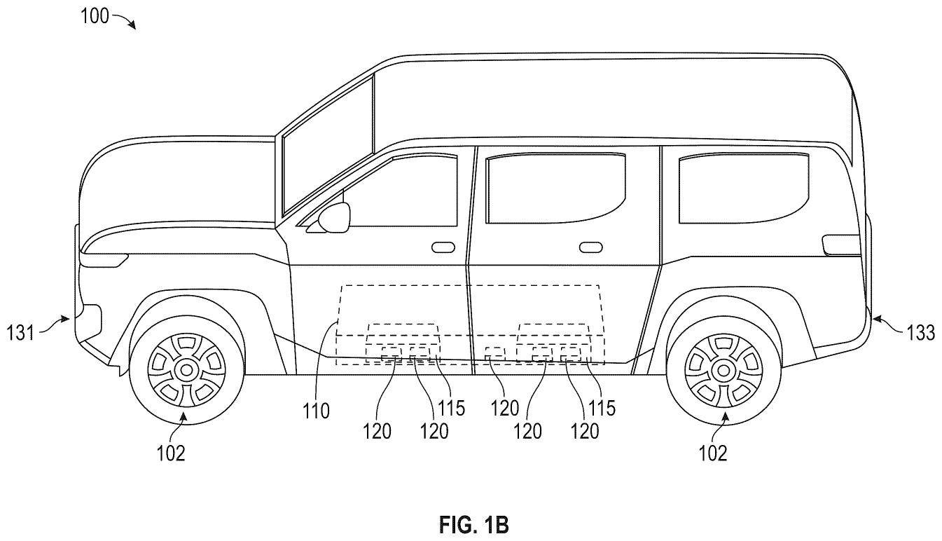

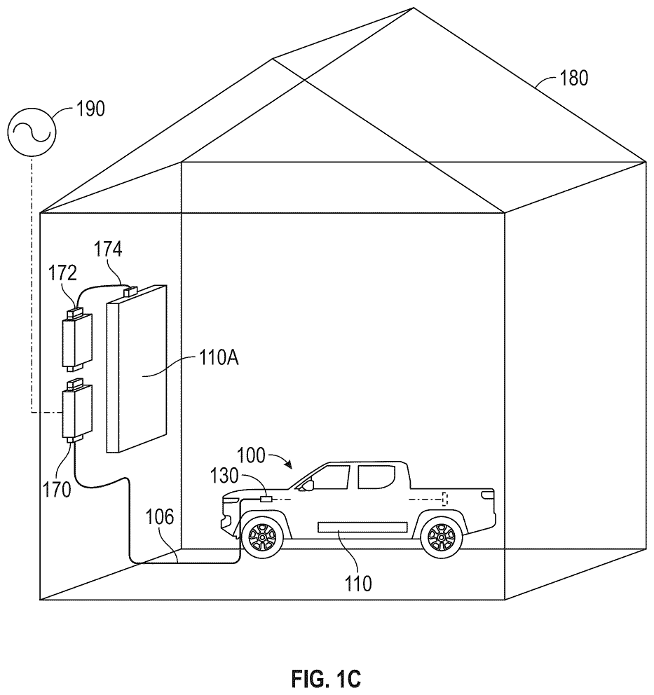

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

For example, the battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100. The vehicle 100 may have a front end 131 and a rear end 133.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

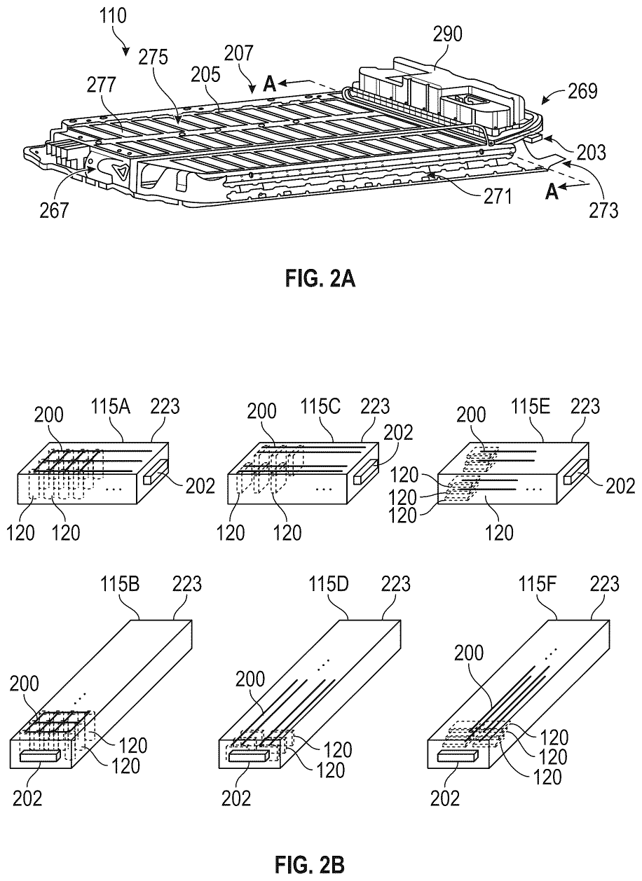

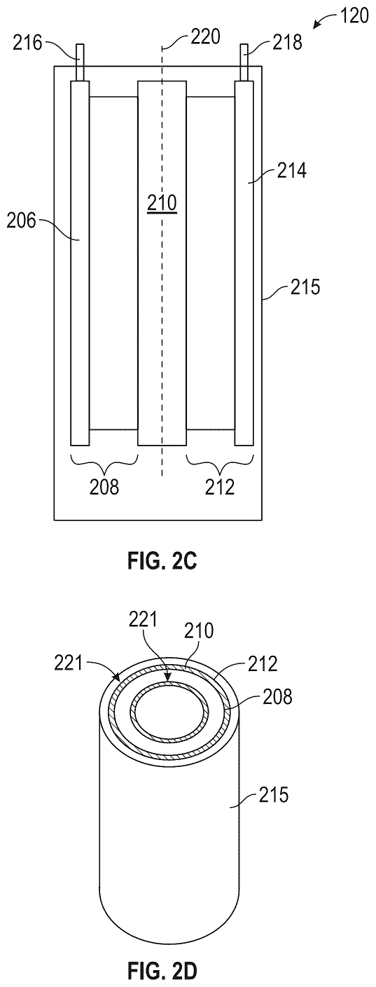

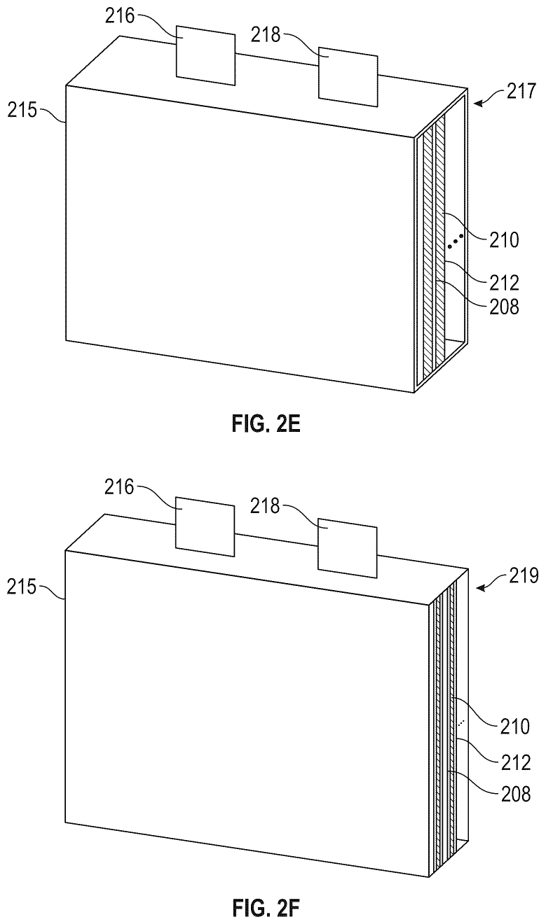

FIG. 2A depicts an example battery pack 110, in accordance with one or more implementations. As shown, the battery pack 110 may include an energy volume enclosure 205 (e.g., a battery pack housing, sometimes referred to herein as an enclosure). For example, the energy volume enclosure 205 may house or enclose an energy volume 207 for the battery pack 110, the energy volume 207 including one or more battery modules 115 and/or one or more battery cells 120, and/or other battery pack components. In one or more implementations, the energy volume enclosure 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

Battery pack 110 may include, within the energy volume 207 and the energy volume enclosure 205, multiple battery cells 120 (e.g., directly installed within the battery pack 110, or within batteries, battery units, battery subassemblies, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, battery subassemblies, and/or multiple battery modules 115 within the energy volume enclosure 205 to generate a desired output voltage for the battery pack 110.

As shown, the battery pack 110 may also include a modular electrical component assembly 290 (e.g., including a modular electronic component enclosure or a modular electrical component enclosure) mounted to the energy volume enclosure 205. In one or more implementations, the modular electrical component assembly 290 may include one or more of the conductive coupling elements for routing power from the battery cells 120 and/or battery modules 115 within the energy volume enclosure 205 (e.g., within the energy volume 207) to one or more external connection ports, such as an electrical contact 203 (e.g., a high voltage terminal, port, or connector). For example, an electrical cable or harness may be connected between the electrical contact 203 and an electrical system of the vehicle 100 or the building 180, to provide electrical power to the vehicle 100 or the building 180. The energy volume enclosure 205 may have a front end 267 and a rear end 269. In one or more implementations, when the battery pack 110 is installed in the vehicle 100, the battery pack 110 may be arranged with the front end 267 closer to the front end 131 of the vehicle and the rear end 269 closer to the rear end 133 of the vehicle. As shown, the modular electrical component assembly 290 may be mounted to the energy volume enclosure 205 (e.g., to a lid 277 of the energy volume enclosure 205) at or near the rear end 269 in one or more implementations. As discussed in further detail hereinafter, the modular electrical component assembly 290 may include operational circuitry for the battery pack 110, such as a battery management system (BMS), which may be electrically and/or communicatively coupled to one or more components (e.g., battery cells, battery modules, sensors, and/or other circuitry) within the energy volume 207.

In one or more implementations, the battery pack 110 may include one or more additional features, such as thermal control structures (e.g., cooling lines and/or plates and/or heating lines and/or plates). For example, thermal control structures may couple thermal control structures and/or fluids to the battery modules 115, battery units, batteries, and/or battery cells 120 within the energy volume enclosure 205, such as by distributing fluid through the battery pack 110.

For example, the thermal control structures may form a part of a thermal/temperature control or heat exchange system that includes one or more thermal components such as plates or bladders that are disposed in thermal contact with one or more battery modules 115 and/or battery cells 120 disposed within the energy volume enclosure 205. For example, a thermal component may be positioned in contact with one or more battery modules 115, battery units, batteries, and/or battery cells 120 within the energy volume enclosure 205. In one or more implementations, the battery pack 110 may include one or multiple thermal control structures and/or other thermal components for each of several top and bottom battery module pairs. As shown, the battery pack 110 may include an electrical contact 203 (e.g., a high voltage connector or port) by which an external load (e.g., the vehicle 100 or an electrical system of the building 180) may be electrically coupled to the battery modules and/or battery cells in the battery pack 110.

As shown, the energy volume enclosure 205 of the battery pack 110 may include a lid 277. For example, the lid 277 may cover and extend over one or more battery modules 115, battery cells 120, and/or other battery subassemblies within the energy volume enclosure 205. In the example of FIG. 2A, the lid 277 may be a deep-drawn structure that forms a top 257, and one or more sidewalls 259 (e.g., four sidewalls), of the energy volume enclosure 205. As discussed in further detail hereinafter, the energy volume enclosure 205 may also include a tray or other housing structure (e.g., at the bottom of the energy volume enclosure) that interfaces with the lid 277 to enclose one or more battery modules 115, battery cells 120, and/or other battery subassemblies within the energy volume enclosure 205 (e.g., within a space defined by the top and the sidewalls of the lid 277). For example, the energy volume enclosure 205 may include a tray panel that is removable to expose an opening in the bottom of the lid 277.

In the example of FIG. 2A, the lid 277 is provided with ribbing 275 (e.g., for additional strength). In the example of FIG. 2A, the battery pack 110 includes one or more mounting features 273 (e.g., for mounting the battery pack 110 to one or more body structures of a vehicle, such as the vehicle 100). As shown in FIG. 2A, and as discussed in further detail hereinafter, the energy volume enclosure 205 may include one or more sidewall structures 271. The sidewall structures 271 may be attached to, and/or extend long, a sidewall 259 of the lid 277, and may provide impact absorption and/or redistribution functions to distribute energy from a side impact to the battery pack 110 (e.g., from a side impact to a vehicle 100) away from and/or around the one or more battery modules 115, battery cells 120, and/or other battery subassemblies within the energy volume enclosure 205.

FIG. 2B depicts various examples of battery modules 115 that may be disposed in the battery pack 110 (e.g., within the energy volume enclosure 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the energy volume enclosure 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the energy volume enclosure 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the energy volume enclosure 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation). In one or more implementations, a battery pack 110 may be provided with three elongated battery modules (e.g., three of battery modules 115B, 115D, and/or 115F).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the energy volume enclosure 205) may include or define a plurality of structures for positioning of the battery cells 120 directly within the energy volume enclosure 205.

FIG. 2C illustrates a cross-sectional end view of a portion of a battery cell 120. As shown in FIG. 2C, a battery cell 120 may include an anode 208, an electrolyte 210, and a cathode 212, which may be disposed in a cell housing 215. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the electrolyte 210 may be a liquid electrolyte layer or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, sodium ion battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 215 having a cylindrical outer shape. For example, the anode 208, the electrolyte 210, and the cathode 212 may be rolled into one or more substantially cylindrical windings 221. As shown, one or more windings 221 of the anode 208, the electrolyte 210, and the cathode 212 (e.g., and/or one or more separator layers such as separator layer 220) may be disposed within the cell housing 215. For example, a separator layer may be disposed between adjacent ones of the windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 215 having a right prismatic outer shape. As shown, one or more layers of the anode 208, the cathode 212, and the electrolyte 210 disposed therebetween may be disposed (e.g., with separator materials between the layers) within the cell housing 215 having the right prismatic shape. As examples, multiple layer of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 215 having the right prismatic shape. In the implementation of FIG. 2E, the cell housing 215 has a relatively thick cross-sectional width 217 and is formed from a rigid material. For example, the cell housing 215 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 215 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 215 (e.g., a glass to metal feedthrough) as the conductor passes through to cell housing 215 to expose the first terminal 216 and the second terminal 218 outside the cell housing 215 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the electrolyte 210 disposed therebetween may be disposed (e.g., with separator materials between the layers) within the cell housing 215 that forms a flexible or malleable pouch housing. In the implementation of FIG. 2F, the cell housing 215 has a relatively thin cross-sectional width 219. For example, the cell housing 215 in the implementation of FIG. 2F may be formed from a flexible or malleable material (e.g., a foil, such as a metal foil, or film, such as an aluminum-coated plastic film). For example, the cross-sectional width 219 of the cell housing 215 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 215 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 215 of the battery cell 120 can be disposed in the battery module 115, the battery pack 110, or installed in any of the vehicle 100, the building 180, or any other electrically powered component or device.

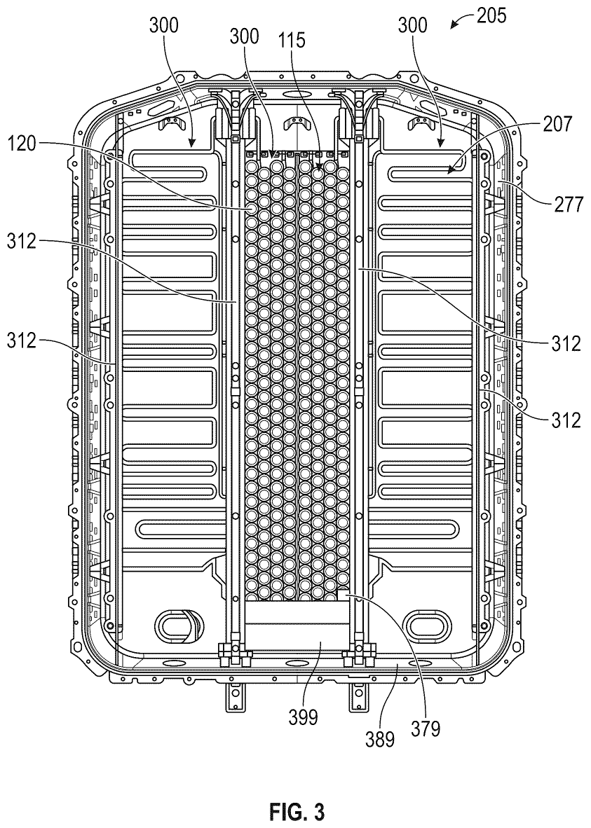

FIG. 3 illustrates a top view of a portion of the energy volume enclosure 205 of the battery pack 110, with battery cells 120 (e.g., one battery module 115 having multiple battery cells 120) installed therein. As shown, the energy volume enclosure 205 may define the energy volume 207, and may include one or more spaces 300 (e.g., one or more module bays), within the energy volume 207, for receiving battery cells 120. In the example of FIG. 3, the energy volume enclosure 205 includes three spaces 300 (e.g., three module bays) for receiving three sets of battery cells 120 (e.g., three battery modules 115 or other battery subassemblies). As shown, the spaces 300 may be separated by structural members (e.g., support structures) of the energy volume enclosure 205. For example, the three spaces 300 may be separated from each other by two longitudinal members 312 that run from the front end 267 to the rear end 269 of the enclosure. The longitudinal members 312 may be structural members that provide strength (e.g., rigidity, impact resistance, and/or force mitigation and/or redirection in the event of an impact) along the front-to-rear (e.g., and rear-to-front) direction of the battery pack 110. As shown, the enclosure 205 may also include one or more crossmembers, such as crossmember 389 (e.g., a rear crossmember). As shown, may extend (e.g., orthogonally to the longitudinal members 312) from a first side of the enclosure to a second side of the enclosure and provide left-to-right (e.g., and right-to-left) strength for the enclosure.

In the example of FIG. 3, battery cells 120 are installed within one of the spaces 300 in the energy volume enclosure 205 (e.g., in the lid 277) between the two longitudinal members 312 that run from the front end 267 to the rear end 269 of the enclosure. In one or more implementations, the battery cells 120 may be installed in the lid 277 while the lid is in an inverted orientation, and the lid may be flipped following insertion of the battery cells 120, to form a top and sidewalls of the energy volume enclosure 205. In other implementations, the battery cells 120 may be installed into or on a base of the energy volume enclosure 205 and the lid 277 may be placed over the battery cells 120.

As shown in FIG. 3, a battery pack may include processing circuitry 399 that is disposed within the energy volume 207 (e.g., within the energy volume enclosure 205). For example, the processing circuitry 399 may include monitoring circuitry, such as balancing temperature and voltage (BVT) circuitry for the battery pack 110. For example, the BVT circuitry may include an electrical control unit (ECU) that obtains data (e.g., voltage data, such as cell voltage data, and/or temperature data, such as one or more temperatures at one or more locations within the energy volume 207) from one or more sensors 379 within the energy volume 207. Although a single sensor 379 is shown in FIG. 3, it is understood that the battery pack 110 may include multiple sensors 379 within the energy volume 207 (e.g., and communicatively coupled to the BVTs). In one or more implementations, sensor 379 may be or include a temperature, a pressure, and/or a gas sensor. In one or more implementations, the sensor(s) 379 may be located at or near an end of one or more of the battery modules 115. Providing the sensor at or near the end(s) of one or more of the battery modules 115 reduce the need for multiple sensors, which may reduce redundancy and cost in vehicle manufacturing.

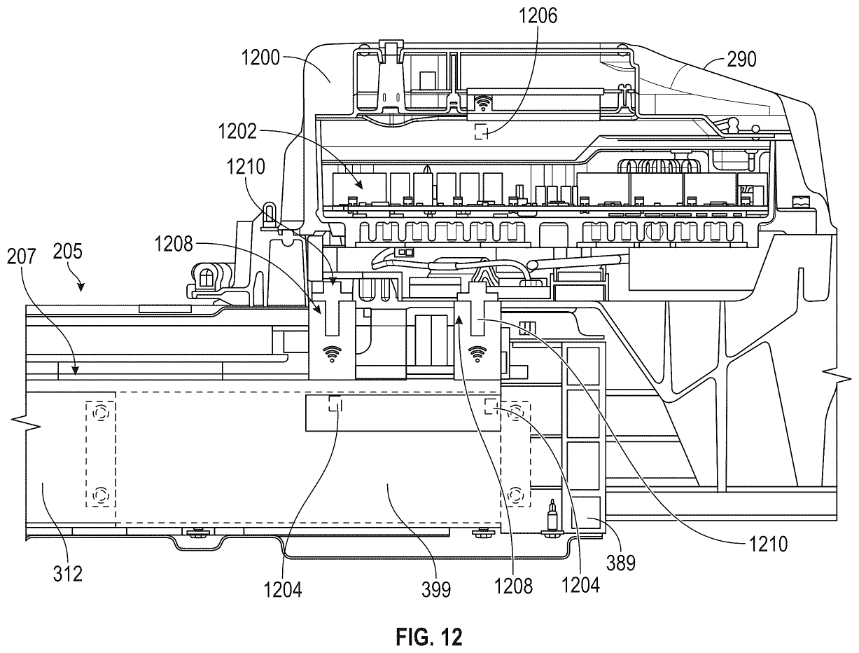

The BVT may process the sensor data to monitor battery cell voltages, monitor one or more temperatures, and/or execute cell balancing operations for the battery cells 120. In one or more implementations, the BVT may provide sensor data, and/or processed data derived from the sensor data, to additional processing circuitry (e.g., a battery management system (BMS)) external to the energy volume 207 (e.g., in the modular electrical component assembly 290), such as via a wired or wireless connection (e.g., as discussed in further detail hereinafter in connection with FIG. 12).

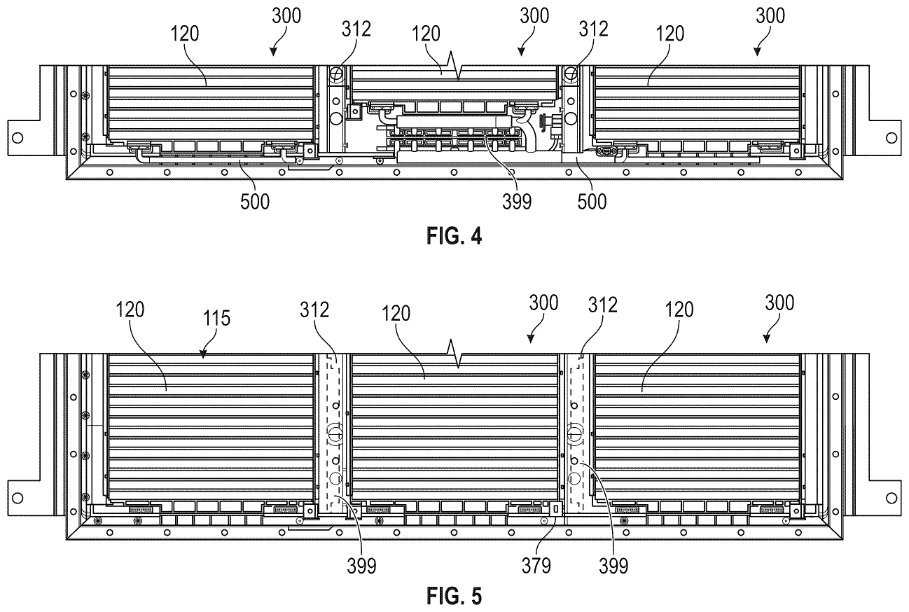

In the example of FIG. 3, the battery cells 120 are depicted as cylindrical cells (e.g., nickel, cobalt, manganese, aluminum (NCMA) or other cylindrical form factor cells having other cell chemistries). However, this is merely illustrative. FIG. 4 illustrates another implementation of a portion of the energy volume enclosure 205 in which the battery cells 120 are implemented as prismatic (e.g., lithium iron phosphate (LFP), or other prismatic form factor cells with other cell chemistries). In the examples of each of FIGS. 3 and 4, the processing circuitry 399 occupies a portion of one of the spaces 300 that could otherwise be occupied by battery cells 120. For example, FIG. 4 illustrates how the outer spaces 300 (e.g., the two spaces 300 that are outward of the longitudinal members 312) can be filled with battery cells 120 up to the rear wall (e.g., a rear crossmember 389) of the energy volume enclosure 205 (e.g., the lid 277), while the middle one of the spaces 300 includes fewer battery cells 120 to accommodate the processing circuitry 399 in this example.

In accordance with aspects of the subject technology, additional space for battery cells 120 may be provided by locating the processing circuitry 399 within one or more of the support structures (e.g., the longitudinal members 312 and/or the crossmember 389) of the energy volume enclosure 205. For example, FIG. 5 illustrates an implementation in which the processing circuitry 399 is housed within the longitudinal members 312. For example, the battery pack 110 may include one BVT module in each of two longitudinal members 312, as in the example of FIG. 5. In this example, one of the two BVTs may manage BVT operations for two battery modules 115 (or other sets or subassemblies of the battery cells 120) and the other of the two BVTs may manage BVT operations for the third battery module 115 (or other set or subassembly of the battery cells 120). In another example, one BVT may be provided for each battery module 115 (or other set or subassembly of the battery cells 120), such as by providing two BVTs in one of the longitudinal members 312 and one BVT in another of the longitudinal members 312.

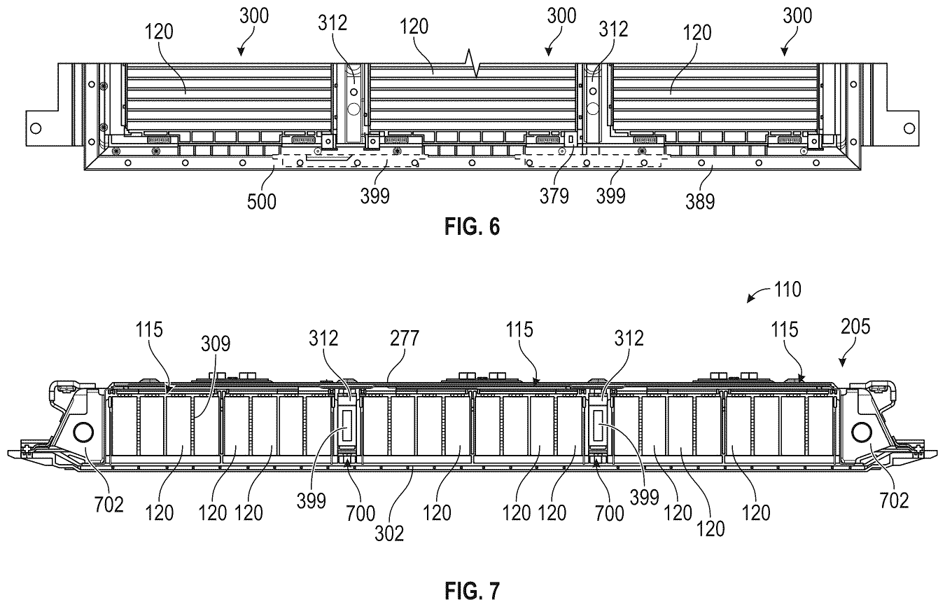

In one or more implementations, processing circuitry (e.g., BVTs) may also, or alternatively, be provided in one or more other support structures of the energy volume enclosure 205. For example, FIG. 6 illustrates an implementation in which the processing circuitry 399 is housed within the crossmember 389. For example, the battery pack 110 may include two BVTs within the crossmember 389, as in the example of FIG. 6. In this example, one of the two BVTs may manage BVT operations for two battery modules 115 (or other sets or subassemblies of the battery cells 120, such as cylindrical cells, prismatic cells, and/or any other chemistry and form factor of battery cells) and the other of the two BVTs may manage BVT operations for the third battery module 115 (or other set or subassembly of the battery cells 120). In another example, one BVT may be provided within the crossmember 389 for each battery module 115 (or other set or subassembly of the battery cells 120), such as by providing three BVTs in the crossmember 389. In one or more implementations, one or more BVTs may also, or alternatively, be provided in one or more other crossmembers of the enclosure 205.

FIG. 7 illustrates a cross-sectional end view of the battery pack of FIG. 3, with battery cells 120 (e.g., cylindrical cells in this example) installed in each of the three spaces 300 within the energy volume enclosure 205. As shown, the processing circuitry 399 may be mounted within the longitudinal members 312. In one or more implementations, the longitudinal members 312 (e.g., and/or the crossmember 389) may have an opening 700 in a bottom thereof. In one or more implementations, the battery cells 120 may be installed in the spaces 300 while the lid 277 is in an inverted orientation, and the processing circuitry 399 may be installed in the cavities within the longitudinal members 312 (e.g., and/or the crossmember 389) while the lid having the longitudinal members 312 (e.g., and/or the crossmember 389) is in the inverted position. The lid 277 may then be inverted so that the opening 700 provides bottom access to the processing circuitry 399 (e.g., for servicing, such as removing, repairing, and/or replacing the processing circuitry 399), such as while the battery pack 110 is installed in the vehicle 100 (e.g., without removing the battery pack 110 from the vehicle during servicing of the processing circuitry 399). FIG. 7 also shows how the energy volume enclosure 205 may include sidewalls 702. In one or more implementations, portions or all of the processing circuitry 399 may be disposed within one or both of the sidewalls 702, and/or one or more additional longitudinal members within or along the sidewalls 702.

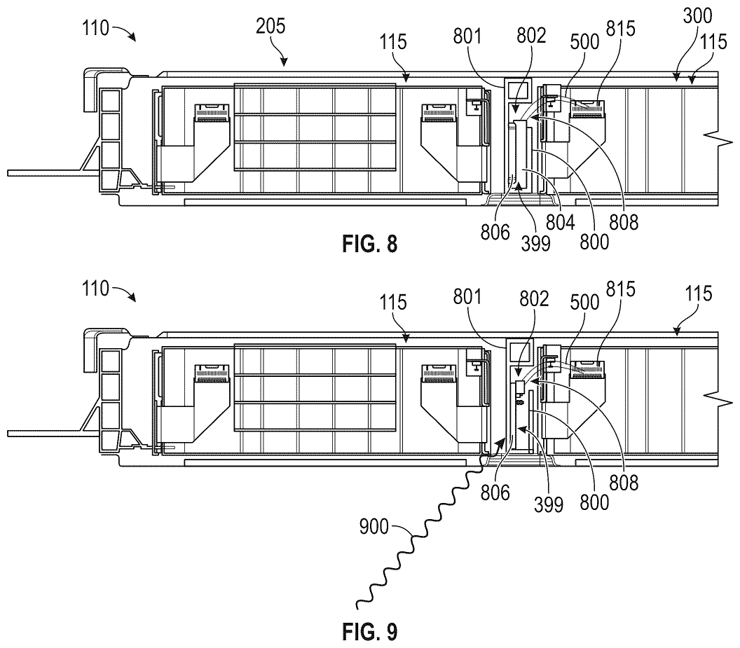

FIG. 8 illustrates a cross-sectional view of a portion of a battery pack 110 having an enclosure and a support structure for the enclosure. For example, the support structure 801 of FIG. 8 may represent a longitudinal member 312 of the energy volume enclosure 205, a crossmember 389 of the energy volume enclosure 205, or another support structure (e.g., a front crossmember) of the energy volume enclosure 205. In various implementations, the support structure 801 may extend from a front end of the enclosure 205 to a rear end of the enclosure 205 and provide front-to-rear strength (e.g., structural resistance to bending, compression, and/or other movement or deformation due to a force along a front-to-rear or rear-to-front direction of the enclosure 205, battery pack 110, and/or vehicle 100) for the enclosure 205, may extend from a first side of the enclosure 205 to a second side of the enclosure 205 and provides left-to-right strength (e.g., structural resistance to bending, compression, or other movement or deformation due to a force along a left-to-right or right-to-left direction of the enclosure 205, battery pack 110, and/or vehicle 100) for the enclosure 205, or may extend in any other direction through, across, and/or along the enclosure 205.

As shown in FIG. 8, the support structure 801 may have a body 800 that provides rigidity and strength for the support structure and the enclosure in which it is implemented. As shown, the processing circuitry 399 may be housed within a cavity 802 within (e.g., and defined by) the body 800. As shown, the body may include an opening 808 or a cutout that allows cabling 500 (e.g., one or more wires and/or cables) to pass from the space 300 within the energy volume 207 and external to the support structure 801 to the processing circuitry 399 within the cavity 802. As examples, the cabling 500 may couple the processing circuitry 399 (e.g., via one or more connectors 815) to one or more sensors (e.g., sensor(s) 379) within the energy volume enclosure 205 and/or to external processing circuitry, such as a BMS that is located in the modular electrical component assembly 290.

In the example of FIG. 8, the processing circuitry 399 includes circuit components 806 (e.g., a printed circuit board on which one or more integrated circuits and/or other circuitry are mounted) and a circuitry housing 804 that at least partially encloses the circuit components 806. For example, the circuitry housing 804 may provide physical protection and/or electromagnetic interference protection for the circuit components 806. However, as illustrated in FIG. 9, in one or more other implementations, the processing circuitry 399 within the support structure 801 may be provided without the circuitry housing 804. For example, the support structure 801 may be formed from a material (e.g., a metal) that provides physical protection and/or electromagnetic interference protection for the circuit components 806, reducing or removing the need for a separate circuitry housing 804. For example, the body 800 may prevent electromagnetic radiation 900 originating outside the support structure 801 from reaching (e.g., and interfering with) the processing circuitry 399. The body 800 may also prevent electromagnetic radiation generated by the operation of the processing circuitry 399 from exiting the support structure 801 and interfering with other components and/or circuitry in the battery pack and/or vehicle. In the example of FIG. 9, the circuit component 806 may be directly mounted to an interior surface of the support structure 801 as shown in FIG. 9.

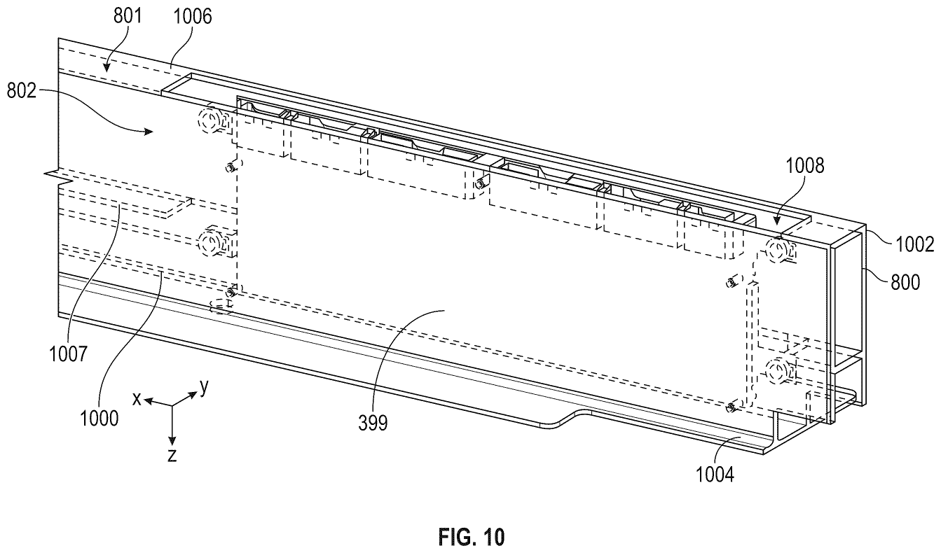

FIG. 10 illustrates a perspective view of another example implementation of the support structure 801 having a cavity 802 within which the processing circuitry 399 may be disposed. In the example of FIG. 10, the body 800 of the support structure 801 includes a first sidewall 1000, a second sidewall 1002, and first and second end walls 1004 and 1006 that extend between the first sidewall 1000 and the second sidewall 1002. As shown, the cavity 802 may be at least partially defined by the first and second end walls 1004 and 1006 and the first sidewall 1000 and the second sidewall 1002. In the example of FIG. 10, the body 800 includes an opening 1008 in the first end wall 1004. In one or more implementations, the opening 1008 may correspond to the opening 808 of FIGS. 8 and 9, and may allow cabling 500 to pass therethrough from the processing circuitry 399 into the space(s) 300 external to the support structure within the enclosure 205.

In one or more implementations, the opening 1008 may be sized and positioned to allow the processing circuitry 399 to be accessed, serviced, installed, and/or removed via the opening 1008. In one or more implementations, the opening 1008 may be provided at or near a bottom of the support structure 801 when the support structure 801 is implemented in the enclosure 205 (e.g., corresponding to the opening 700 of FIG. 7 in some implementations). For example, the opening 1008 may allow access to the cavity 802 (e.g., from beneath a vehicle 100 in which the battery pack having the support structure 801 is installed), such as for servicing of the processing circuitry 399, in one or more implementations. In one or more other implementations, the first end wall 1004 (e.g., or a portion thereof) may be removable or omitted to allow access to the cavity 802 from the bottom of the vehicle 100 when the enclosure 205 including the support structure 801 is installed in the vehicle.

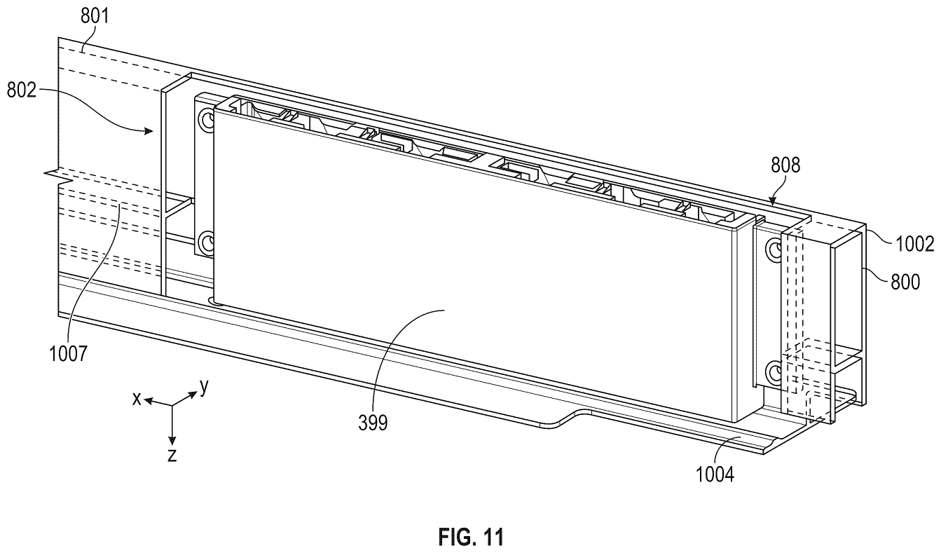

In various implementations, the processing circuitry 399 may be installed in the cavity 802 from various directions, such as along the x-, y-, or z-directions of FIG. 10. In one example, the processing circuitry 399 may be installed in the cavity 802 along the z-direction of FIG. 10. As examples, the processing circuitry 399 may be installed into the cavity 802 along the z-direction via the opening 1008, or may be installed into the cavity 802 along the z-direction at a time when the first sidewall 1000 (e.g., or a portion thereof) is not present (e.g., has been removed or has not yet been added to the support structure 801). For example, FIG. 11 illustrates an example in which at least a portion of the first sidewall 1000 is not present (e.g., has been removed or has not yet been added to the support structure 801). In this example, the processing circuitry 399 may be installed into the cavity 802 along the y-direction or the z-direction of FIGS. 10 and 11, and the first sidewall 1000 may then be attached to the body 800 to enclose the cavity 802 and the processing circuitry 399 therein. As shown in FIGS. 10 and 11, in one or more implementations, the support structure 801 may include one or more cross-ribs, such as a cross-rib 1007. As shown, the cross-rib 1007 may be internal to the body 800 of the support structure 801, and may include a cutout or a truncation that at least partially defines the cavity 802 and provides space to accommodate the processing circuitry 399.

FIG. 12 illustrates a cross-sectional side view of a portion of the battery pack 110, in an implementation in which processing circuitry 399 is disposed within at least one of the longitudinal members 312. In the example of FIG. 12, the longitudinal member 312 is shown in partial transparency, so that the processing circuitry 399 (e.g., a BVT module) can be seen therein.

In the cross-sectional view of FIG. 12, operational circuitry 1202 for the battery pack 110 can be seen within an enclosure housing 1200 of the modular electrical component assembly 290, which is mounted to the energy volume enclosure 205. For example, the operational circuitry 1202 may include a battery management system (BMS) that performs various battery management operations for the battery pack 110 and/or the vehicle 100 (or other system) in which the BMS is installed. For example, the BMS may perform battery management operations based on battery information received from the processing circuitry 399 (e.g., one or more BVTs). As examples, the BMS may monitor, based on the battery information received from the processing circuitry 399, one or more output voltages, output currents, and/or temperatures of the battery pack 110. Further, the BMS may control and/or regulate the output voltage(s) and/or output current(s), which may also control the temperature of the battery pack 110. The BMS may optimize performance of the battery pack 110, as well as manage the battery pack 110 based on an operational mode of a vehicle 100 (or other system in which the battery pack 110 is implemented) in some implementations.

In one or more implementations, the processing circuitry 399 may be provided with one or more antennas 1204 for wireless communication with the operational circuitry 1202 (e.g., via an antenna 1206 of the operational circuitry 1202). In the example of FIG. 12, the battery pack 110 is structurally configured to allow the battery information to be transmitted wirelessly from the processing circuitry 399, within the longitudinal member 312 in the energy volume 207, to the operational circuitry 1202 within modular electrical component assembly 290. For example, the energy volume enclosure 205 may be provided with one or more openings 1208. As shown, the openings 1208 may be aligned with one or more antennas 1204 of the processing circuitry 399. In this way, the openings 1208 may be configured as wireless transmission windows or apertures between the energy volume 207 and the operational circuitry 1202 within the modular electrical component assembly 290.

As shown in the example of FIG. 12, the openings 1208 may be formed in association with structural interfaces for mounting the modular electrical component assembly 290 to the energy volume enclosure 205. For example, one or more mounting features 1210 (e.g., bolts or other fasteners) that secure the modular electrical component assembly 290 to the energy volume enclosure 205 may pass through portions of the one or more openings 1208 that provide the wireless communications windows between the modular electrical component assembly 290 and the energy volume 207. In this way, the openings 1208 may facilitate structural and communications connections between the modular electrical component assembly 290 and the energy volume 207. For example, the openings 1208 may provide locating features for the wireless aperture(s) for transmission, and can be implemented as mounting holes or purpose built ‘window’ cut outs through to the modular electrical component assembly 290 to aid transmission and reception of cell voltages, temperatures, etc. at the operational circuitry 1202 from the processing circuitry 399.

Although the processing circuitry 399 is shown in the longitudinal member 312 in FIG. 12, it is appreciated that, in one or more implementations, the processing circuitry 399 that is in wireless communication with the operational circuitry 1202 (e.g., BMS) may be disposed (e.g., additionally or alternatively) in the crossmember 389 and/or other support structures and/or structural members of the energy volume enclosure 205. Although one set of operational circuitry 1202 (e.g., one control module, or control unit) is visible in the example of FIG. 12, it is appreciated that the modular electrical component assembly 290 may include multiple sets of operational circuitry (e.g., multiple control modules, or submodules, or control units or subunits, such as multiple BMSs and/or other circuitry), such as for interfacing between the battery pack 110 and electrical components in multiple respective zones (e.g., front, rear, left, right, south, north, east, and/or west zones) within the interior of the vehicle.

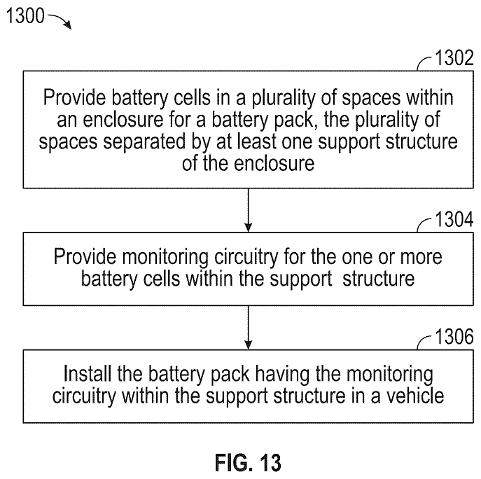

FIG. 13 illustrates a flow diagram of an example process 1300 that may be performed for assembling a vehicle, in accordance with implementations of the subject technology. For explanatory purposes, the process 1300 is primarily described herein with reference to the battery pack 110 of FIGS. 1A-12. However, the process 1300 is not limited to the battery pack 110, and one or more blocks (or operations) of the process 1300 may be performed by or with one or more other structural components of other devices, systems, or battery assemblies or subassemblies.

Further for explanatory purposes, some of the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

As illustrated in FIG. 13, at block 1302, battery cells (e.g., multiple battery cells 120) may be provided (e.g., installed or inserted) in a plurality of spaces (e.g., spaces 300, such as module bays) within an enclosure (e.g., energy volume enclosure 205) for a battery pack (e.g., battery pack 110). The plurality of spaces may be at least partially defined by at least one support structure (e.g., a longitudinal member 312 or a crossmember 389) of the enclosure. In one or more implementations, the plurality of spaces may also be separated from each other by the at least one support structure.

At block 1304, monitoring circuitry (e.g., processing circuitry 399, such as one or more BVT modules) for the one or more battery cells may be provided within the support structure. For example, the monitoring circuitry may be inserted and/or mounted within a cavity (e.g., cavity 802) within the support structure.

At block 1306, the battery pack having the monitoring circuitry within the support structure may be installed in a vehicle (e.g., a vehicle 100, such as an electric vehicle). In one or more implementations, battery information (e.g., voltages and/or temperatures, such as cell voltages and/or cell temperatures, obtained using one or more sensors within the enclosure, may be wirelessly transmitted from the monitoring circuitry to other circuitry (e.g., operational circuitry 1202) external to the enclosure (e.g., in the modular electrical component assembly 290).

In one or more implementations, the process 1300 and/or another process may include servicing the monitoring circuitry without removing the battery pack from the vehicle by, while the battery pack is installed in the vehicle: accessing a cavity (e.g., cavity 802) within the support structure from beneath the vehicle; removing the monitoring circuitry from the cavity; and replacing the monitoring circuitry with replacement monitoring circuitry in the cavity.

Aspects of the subject technology can help improve the range of electric vehicles. This can help facilitate the functioning of and/or proliferation of electric vehicles, which can positively impact the climate by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S. C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application.

Various components and blocks may be arranged differently (e.g., arranged in a different order, or partitioned in a different way) all without departing from the scope of the subject technology. The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus, comprising:
an enclosure for an energy volume for a battery pack, wherein the enclosure comprises a support structure that at least partially defines a space within the enclosure for one or more battery cells,
wherein the support structure is configured to house processing circuitry for monitoring one or more battery cells within the energy volume.

2. The apparatus of claim 1, wherein the support structure comprises a cavity for housing the processing circuitry and at least one opening for allowing cabling to pass from the space within the energy volume and external to the support structure to the processing circuitry within the cavity.

3. The apparatus of claim 2, wherein the support structure comprises a longitudinal member that extends from a front end of the enclosure to a rear end of the enclosure and provides front-to-rear strength for the enclosure.

4. The apparatus of claim 3, wherein the enclosure comprises an additional longitudinal member, and additional processing circuitry disposed within the additional longitudinal member for monitoring the one or more battery cells.

5. The apparatus of claim 2, wherein the support structure comprises a crossmember that extends from a first side of the enclosure to a second side of the enclosure and provides left-to-right strength for the enclosure.

6. The apparatus of claim 5, wherein the crossmember comprises a rear crossmember that forms at least a portion of a rear wall of the enclosure.

7. The apparatus of claim 5, wherein the crossmember comprises a front crossmember that forms at least a portion of a front wall of the enclosure.

8. The apparatus of claim 5, wherein the crossmember comprises a bottom opening, and the processing circuitry is serviceable, via the bottom opening, from a bottom of the battery pack.

9. The apparatus of claim 2, wherein the processing circuitry is provided in a circuitry housing that is mounted in the cavity.

10. The apparatus of claim 2, wherein the processing circuitry is mounted directly to the support structure in the cavity, and wherein the support structure provides electromagnetic interference protection for the processing circuitry.

11. The apparatus of claim 1, wherein the apparatus comprises an electric vehicle, and wherein the processing circuitry for monitoring the one or more battery cells within the energy volume comprises one or more antennas for wireless communication with operational circuitry for the battery pack, wherein the operational circuitry is external to the enclosure for the energy volume for the battery pack.

12. A battery pack, comprising:
an enclosure for an energy volume for a battery pack, wherein the enclosure comprises a support structure that at least partially defines a space within the enclosure for one or more battery cells,
wherein the support structure is configured to house processing circuitry for monitoring one or more battery cells within the energy volume.

13. The battery pack of claim 12, further comprising the processing circuitry within the support structure.

14. The battery pack of claim 12, wherein the support structure comprises a cavity for housing the processing circuitry and at least one opening for allowing cabling to pass from the space within the energy volume and external to the support structure to the processing circuitry within the cavity.

15. The battery pack of claim 14, wherein the support structure comprises a longitudinal member that extends from a front end of the enclosure to a rear end of the enclosure and provides front-to-rear strength for the enclosure.

16. The battery pack of claim 15, wherein the enclosure comprises an additional longitudinal member, and additional processing circuitry disposed within the additional longitudinal member for monitoring the one or more battery cells.

17. The battery pack of claim 14, wherein the support structure comprises a crossmember that extends from a first side of the enclosure to a second side of the enclosure and provides left-to-right strength for the enclosure.

18. The battery pack of claim 14, wherein the processing circuitry is mounted directly to the support structure in the cavity, and wherein the support structure provides electromagnetic interference protection for the processing circuitry.

19. A method of assembling a vehicle, the method comprising:
providing battery cells in a plurality of spaces within an enclosure for a battery pack, the plurality of spaces separated by at least one support structure of the enclosure;
providing monitoring circuitry for the one or more battery cells within the support structure; and
installing the battery pack having the monitoring circuitry within the support structure in the vehicle.

20. The method of claim 19, further comprising:
servicing the monitoring circuitry without removing the battery pack from the vehicle by, while the battery pack is installed in the vehicle:
accessing a cavity within the support structure from beneath the vehicle;
removing the monitoring circuitry from the cavity; and
replacing the monitoring circuitry with replacement monitoring circuitry in the cavity.
